(19) United States
(12) Patent Application Publication
(10) Pub. No.: US 2010/0255726 A1
(43) Pub. Date: Oct. 7, 2010

(54) ELECTRICAL CONNECTOR WITH MAGNETIC MODULE

(75) Inventors: CHAO-TUNG HUANG, Tu-Cheng (TW); YONG-CHUN XU, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/753,116

(22) Filed: Apr. 2, 2010

(30) Foreign Application Priority Data
Apr. 3, 2009 (TW) 98205419

(51) Int. Cl. H01R 13/66; H01R 13/648

(52) U.S. Cl. 439/607.01; 439/620.06

(57) ABSTRACT

An electrical connector (100) to be mounted on a substrate provides signal channels between a first side and a second side. The electrical connector includes a transformer (210), a common mode filter (327) and a separated filter (328). The transformer includes a first wire (314) having two opposite ends electrically connected to said first side and a second wire (312) having two opposite ends and a center tap (313). The common mode filter includes a third wire (322) and a fourth wire (324), each of the third wire (322) and the fourth wire (324) having an end respectively electrically connected to the two opposite ends of the second wire (312). The separated filter (328) includes a fifth wire (326) separated from the common mode filter (327) and the transformer (310), the fifth wire (326) having an end electrically connected to the center tap (313) of the second wire (312). Opposite ends of the third, the fourth and the fifth wires (322, 324, 326) are electrically connected to the second side.

### CROSS-REFERENCE TO RELATED APPLICATIONS

This patent application is related to the following pending U.S. patent applications assigned to the same assignee with this application: application Ser. No. 12/319,299, filed on Jan. 5, 2008, published in Document No. 2009 0176408 A1 on Jul. 9, 2009 and entitled “ELECTRICAL CONNECTOR HAVING AN IMPROVED MAGNETIC MODULE”; application Ser. No. 12/321,470, filed on Jan. 20, 2009, published in Document No. 2009 0186526A1 on Jul. 23, 2009 and entitled “ELECTRICAL CONNECTOR WITH MAGNETIC MODULE”; application Ser. No. 12/508,792, filed on Jul. 24, 2009, published in Document No. 2010 0022133A1 on Jan. 28, 2010 and entitled “ELECTRICAL CONNECTOR WITH MAGNETIC MODULE”; application Ser. No. 12/556,588, filed on Sep. 10, 2009, and entitled “ELECTRICAL CONNECTOR WITH MAGNETIC MODULE”; application Ser. No. 12/584,667, filed on Sep. 9, 2009, and entitled “ELECTRICAL CONNECTOR WITH MAGNETIC MODULE”; and application Ser. No. 12/556,589, filed on Sep. 10, 2009, and entitled “ELECTRICAL CONNECTOR WITH MAGNETIC MODULE”.

### BACKGROUND OF THE INVENTION

1. Field of the Invention

The present invention relates to an electrical connector, and more particularly, to an electrical connector having magnetic module for noise-filter.

2. Description of the Prior Art

Magnetic elements, including transformer and common mode filter, are often used to filter noises in high-speed communication. An electrical connector having magnetic modules with more effective noise filtering, smaller size and lower cost is always a focus of the designers of the field.

### SUMMARY OF THE INVENTION

A main object of the present invention is to provide an electrical connector having transformer (parallel transformer) and common mode filter (serial transformer) which is convenient to be manufactured and assembled with lower cost.

The present invention provides an electrical connector used for a network interface. The electrical connector is used to be mounted on a substrate for providing signal channels between a first and a second side. The electrical connector comprises a transformer, a common mode filter and a separated filter. The transformer includes a first wire having two opposite ends electrically connected to said first side and a second wire having two opposite ends and a center tap. The common mode filter includes a third wire and a fourth wire, each of the third wire and the fourth wire having an end respectively electrically connected to the two opposite ends of the second wire. The separated filter includes a fifth wire separated from the common mode filter and the transformer, the fifth wire having an end electrically connected to the center tap of the second wire. The other ends of the third, the fourth and the fifth wires are electrically connected to the second side.

According to another aspect of the present invention, another electrical connector is provided. The electrical connector is adapted for an Ethernet interface between a physical side and a cable side. The electrical connector comprises a transformer, a common mode filter and a separated filter. The transformer includes a first wire having two opposite ends electrically connected to the cable side and a second wire having two opposite ends and a center tap. The common mode filter includes a third wire and a fourth wire, each of the third wire and the fourth wire having an end respectively electrically connected to the two opposite ends of the second wire. The separated filter includes a fifth wire separated from the common mode filter and the transformer, the fifth wire having an end electrically connected to the center tap of the second wire. The other ends of the third, the fourth and the fifth wires are electrically connected to the physical side.

According one aspect of the present invention, the second wire and the third wire and the fourth wire are physically separated from each other, so that the transformer and the common mode filter could be independently manufactured and conveniently assembled.

### BRIEF DESCRIPTION OF THE DRAWINGS

The features of this invention, which are believed to be novel, are set fourth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector according to a first design and a printed circuit board the electrical connector mounted thereon;

FIG. 2 is an exploded view of an electrical connector shown in FIG. 1;

FIG. 3 is a perspective view of a contact module of an electrical connector shown in FIGS. 1 and 2; and

FIG. 4 is a circuit diagram of signal channels provided by the electrical connector shown in FIG. 1.

### DETAILED DESCRIPTION OF THE INVENTION

Reference will now be made to the drawing figures to describe the present invention in detail.

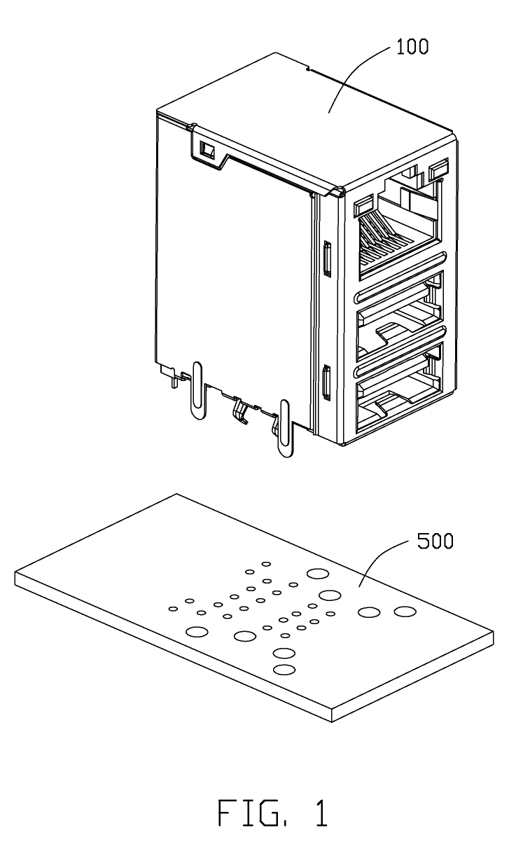

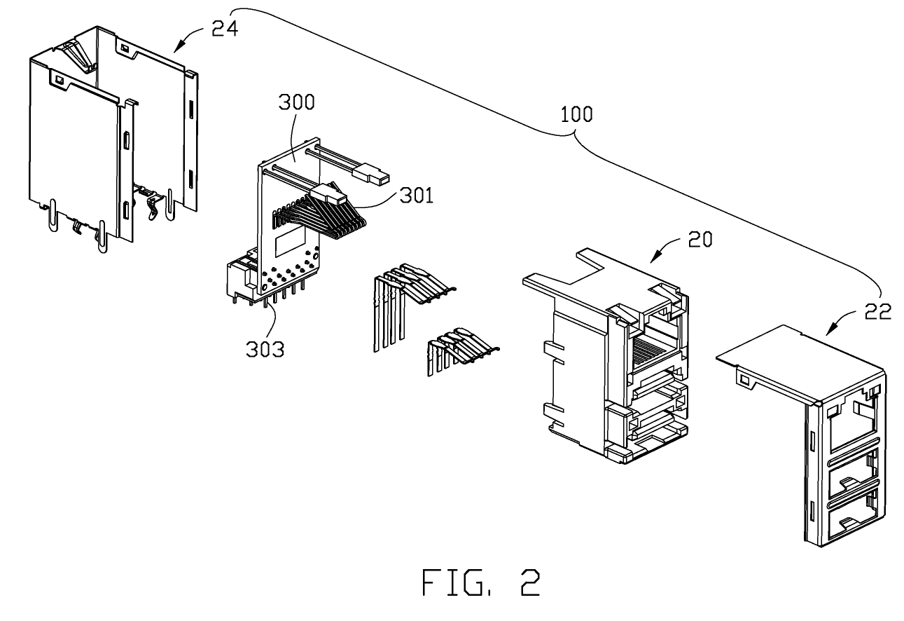

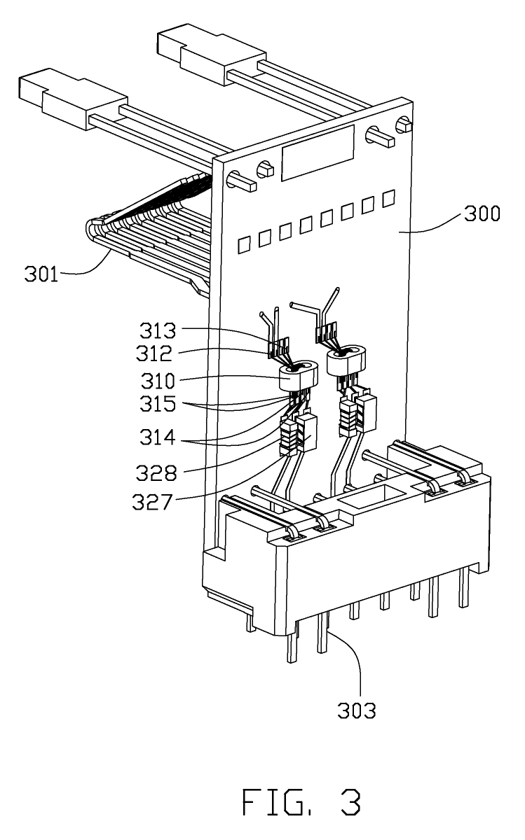

Referring to FIGS. 1-3, an electrical connector 100 to be mounted on a substrate 500 for providing signal channels between a physical side and a cable side is shown. The electrical connector 100 comprises an insulating housing 20, a contact module received in the insulating housing 20, and an EMI shield 22, 24 covering the insulating housing 20. The contact module further comprises two transformers 310, two common mode filters 327, two separated filters 328, a plurality of mating contacts 301, a plurality of transferring contacts 303, and an interior printed circuit board (PCB) 300. Said two transformers 310, two common mode filters 327 and two separated filters 328 are mounted onto said interior PCB 300. The plurality of mating contacts 301 are mounted onto the interior PCB 300 and adapted to mate with a modular plug. The mating contacts 301 form a cable side. The plurality of transferring contacts 303 are mounted onto the interior PCB 300 and electrically connecting to the substrate 500 when the electrical connector 100 is mounted onto the substrate 500. The substrate 500 forms a physical side.

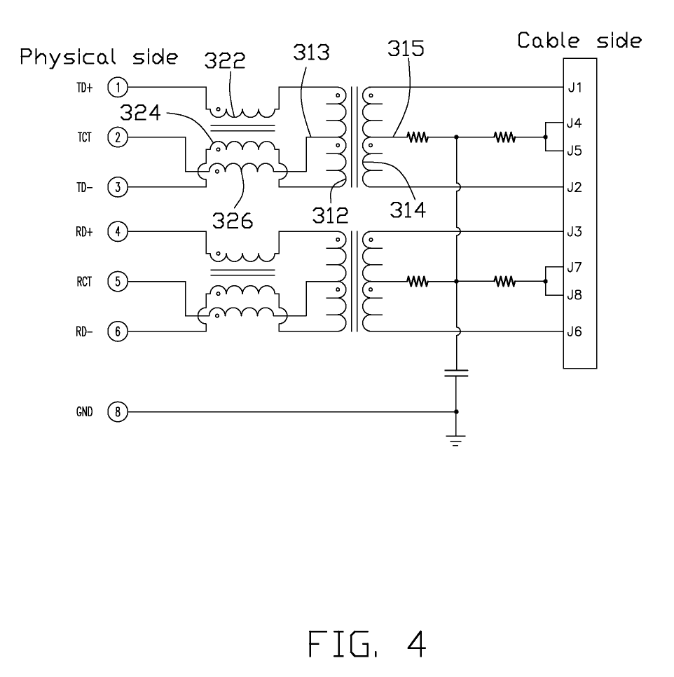

Further referring to FIG. 4, each of the transformers 310 has a first wire 314 and a second wire 312. The first wire 314 has two opposite ends electrically connected to the cable side and a center tap 315 electrically connected to ground. The second wire 312 has two opposite ends and a center tap 313. The common mode filter 327 has a third wire 322 and a fourth wire 324. Each of the third wire 322 and the fourth wire 324 has an end respectively electrically connected to the two opposite ends of the second wire 312 and an opposite end electrically connected to the physical side. The separated filter 328 has a fifth wire 326 and is separated from the common mode filter 327 and the transformer 310. The fifth wire 326 has an end electrically connected to the center tap 313 of the second wire 312 and an opposite end connected to ground of the physical side.

As a preferred embodiment of the present invention, the transformers 310, the common mode filters 327 and the separated filters 328 are made of magnetic cores wound with magnetic wires 314, 312, 322, 324, 326. As a further option, the transformers 310, the common mode filter 327 and the separated filter 328 are manufactured through printed circuit technology.

In the present invention that the common mode filter 327 and the separated filter 328 are separated components decreases the complexity of the common mode filter 327 and thus reduces the cost of manufacture.

It is to be understood, however, that even though numerous characteristics and advantages of the present invention have been set fourth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector to be mounted on a substrate for providing signal channels between a first side and a second side, comprising:
a transformer including a first wire having two opposite ends electrically connected to said first side and a second wire having two opposite ends and a center tap;
a common mode filter including a third wire and a fourth wire, each of the third wire and the fourth wire having an end respectively electrically connected to said two opposite ends of the second wire; and
a separated filter including a fifth wire separated from the common mode filter and the transformer, the fifth wire having an end electrically connected to the center tap of the second wire;
wherein opposite ends of the third, the fourth and the fifth wires are electrically connected to the second side.

2. An electrical connector according to claim 1, wherein the transformer has a first magnetic core, the common mode filter has a second magnetic core, and the separated filter has a third magnetic core.

3. An electrical connector according to claim 1, wherein the third, the fourth and the fifth wires are manufactured through printed circuit technology.

4. An electrical connector according to claim 1, wherein the first wire has a center tap connected to ground.

5. An electrical connector according to claim 1, further comprising an interior PCB having a plurality of circuits, the common mode filter and the separated filter surface-mounted onto said interior PCB and being electrically connected to the channel through the circuits.

6. An electrical connector according to claim 5, further comprising a plurality of mating contacts mounted onto said interior PCB, said plurality of mating contacts being adapted to mate with a cable end connector.

7. An electrical connector according to claim 6, further comprising a plurality of transferring contacts mounted onto said interior PCB, the transferring contacts being adapted to mounted onto said substrate.

8. An electrical connector according to claim 7, further comprising an insulating housing receiving said interior PCB, the mating contacts and the transferring contacts.

9. An electrical connector according to claim 8, further comprising a shield covering said insulating housing.

10. An electrical connector adapted for an Ethernet interface between a physical side and a cable side, comprising:
a transformer including a first wire having two opposite ends electrically connected to said cable side and a second wire having two opposite ends and a center tap;
a common mode filter including a third wire and a fourth wire, each of the third wire and the fourth wire having an end respectively electrically connected to said two opposite ends of the second wire; and
a separated filter including a fifth wire separated from the common mode filter and the transformer, the fifth wire having an end electrically connected to the center tap of the second wire;
wherein opposite ends of the third, the fourth and the fifth wires are electrically connected to the physical side.

11. An electrical connector according to claim 10, wherein the transformer has a first magnetic core, the common mode filter has a second magnetic core, and the separated filter has a third magnetic core.

12. An electrical connector according to claim 10, wherein the third, the fourth and the fifth wires are manufactured through printed circuit technology.

13. An electrical connector according to claim 10, wherein the first wire has a center tap connected to ground.

14. An electrical connector according to claim 10, further comprising an interior PCB having a plurality of circuits, the common mode filter and the separated filter surface-mounted onto said interior PCB and electrically connected to the channel through circuits of the interior PCB.

15. An electrical connector according to claim 14, further comprising a plurality of mating contacts mounted onto said interior PCB, said plurality of mating contacts being adapted to mate with a cable end connector.
